(19) United States
(12) Patent Application Publication
(10) Pub. No.: US 2024/0272828 A1
(43) Pub. Date: Aug. 15, 2024

(54) STORAGE DEVICE AND CONNECTION CHECKING METHOD THEREOF

(71) Applicant: Samsung Electronics Co., Ltd., Suwon-si (KR)

(72) Inventors: Yongseob KIM, Suwon-si (KR); Youngmin KEUM, Suwon-si (KR); Kyumin PARK, Suwon-si (KR); Inseo HAN, Suwon-si (KR)

(73) Assignee: Samsung Electronics Co., Ltd., Suwon-si (KR)

(21) Appl. No.: 18/420,083

(22) Filed: Jan. 23, 2024

(30) Foreign Application Priority Data
Feb. 13, 2023 (KR) 10-2023-0018969
Apr. 26, 2023 (KR) 10-2023-0054436

(51) Int. Cl. G06F 3/06; G06N 20/00

(52) U.S. Cl. CPC G06F 3/0659; G06F 3/061; G06F 3/0679; G06N 20/00

(57) ABSTRACT

A storage device may include a first chip and a second chip connected to the first chip and configured to exchange a plurality of data signals with the first chip. The first chip and the second chip may align the plurality of data signals using a training command during a training operation, and the first chip and the second chip may check whether a connection state between data input/output pins of the first chip and data input/output pins of the second chip is poor, by utilizing the training command, during a connection state checking operation.

### CROSS-REFERENCE TO RELATED APPLICATION(S)

This application claims benefit of priority to Korean Patent Application Nos. 10-2023-0018969, filed on Feb. 13, 2023, and 10-2023-0054436, filed on Apr. 26, 2023, in the Korean Intellectual Property Office, the disclosures of which are incorporated herein by reference in their entirety.

### BACKGROUND

The present disclosure relates to storage devices.

In the semiconductor industry, there is increasing demand for high capacity, thinning, and miniaturization of a semiconductor device and a storage device using the same, and various packaging technologies with respect to the above characteristics are being developed. Integrated circuit chips are typically provided with a semiconductor package to be appropriately applied to electronic products. For example, in a package-on-package (PoP) structure that is a representative package structure, a chip implemented as a package is disposed on a chip implemented as a package. In such packaging technology, it is necessary to check whether there are no defects in the connections between chips and the connections between chips and printed circuit boards (PCBs).

### SUMMARY

Some example embodiments provide storage devices that are capable of effectively checking whether a connection state is poor.

According to an example embodiment, a storage device may include a first chip, and a second chip connected to the first chip and configured to exchange a plurality of data signals with the first chip, wherein the first chip and the second chip are configured to align the plurality of data signals using a training command during a training operation, and the first chip and the second chip are configured to check whether a connection state between first data input/output pins of the first chip and second data input/output pins of the second chip is poor, by utilizing the training command, during a connection state checking operation.

According to an example embodiment, a method of checking a connection state between a first chip and a second chip may include setting a frequency of a clock signal transmitted from the first chip to the second chip, to be lower than a frequency in a training operation, transmitting a training command from the first chip to the second chip, transmitting a training pattern stored in the second chip to the first chip in response to the training command, and determining a connection relationship between the first chip and the second chip based on a training pattern stored in the first chip and the training pattern transmitted from the second chip, wherein the training command and the training pattern stored in the first chip are a command and a pattern used for the training operation, respectively.

According to an example embodiment, a system-on-chip connected to a DRAM device, the system-on-chip may include processing circuitry configured to set a training pattern, a plurality of data pins connected to the DRAM device and configured to transmit the training pattern to the DRAM device, and the processing circuitry further configured to determine whether a state of connection to the DRAM device is poor, based on a training pattern received from the DRAM device and the training pattern stored in the system-on-chip, during a connection state checking operation, wherein the training pattern stored in the system-on-chip is transmitted to the DRAM device during a training operation.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic block diagram illustrating an example of a storage device 1000 according to an example embodiment.

FIG. 2 is a flowchart illustrating an example of an operation of checking a connection state of the storage device 1000 of FIG. 1.

FIG. 3 is a schematic block diagram illustrating an example of the storage device of FIG. 1.

FIG. 4 is a cross-sectional view illustrating an example of a structure of the storage device of FIG. 3.

FIG. 5 is a block diagram illustrating an example of a system-on-chip of FIG. 3.

FIG. 6 is a block diagram illustrating an example of a DRAM device of FIG. 3.

FIGS. 7A and 7B are diagrams illustrating an operation of checking a connection state according to an example embodiment.

FIGS. 8A and 8B are diagrams illustrating an operation of checking a connection state according to an example embodiment.

FIG. 9 is a flowchart illustrating an example of an operation of checking a connection state using a read training command.

FIG. 10 is a diagram illustrating an operation of checking a connection state according to an example embodiment.

FIG. 11 is a flowchart illustrating an example of an operation of checking a connection state using a write training command.

FIGS. 12A, 12B, and 12C are diagrams illustrating DRAM devices having a plurality of channels according to some example embodiments.

FIG. 13 is a flowchart illustrating an example of an operation of checking a connection state to a DRAM device having a multi-channel structure.

FIG. 14 is a diagram illustrating another example of the storage device of FIG. 1.

FIG. 15 is a block diagram illustrating a nonvolatile memory device of FIG. 14 in more detail.

FIG. 16 is a diagram illustrating another example of the storage device of FIG. 1.

FIG. 17 is a diagram illustrating an operation of a connection state between a controller and an interface circuit in the storage device of FIG. 16.

FIG. 18 is a diagram illustrating an operation of checking a connection state between the interface circuit 1300 and nonvolatile memories in the storage device of FIG. 16.

### DETAILED DESCRIPTION

Hereinafter, some example embodiments will be described with reference to the accompanying drawings.

While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

### [Storage Device Checking Whether Connection State is Poor Using a Training Command]

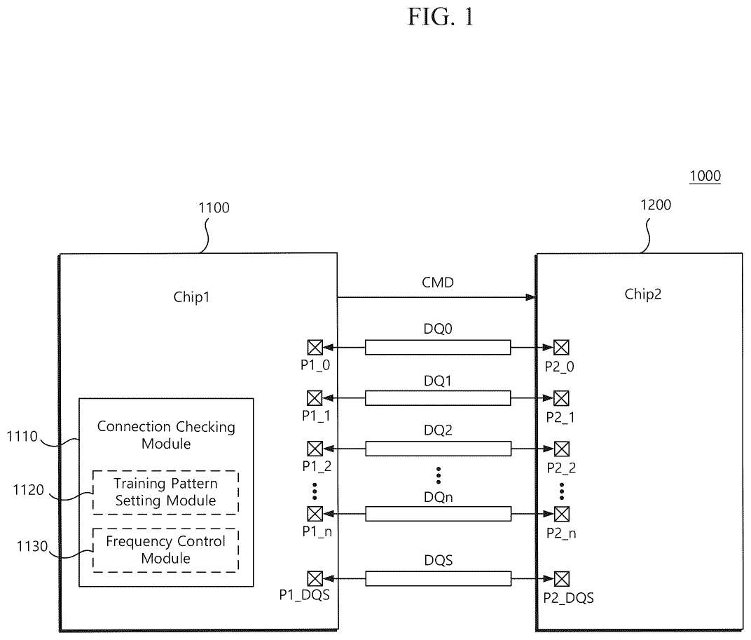

FIG. 1 is a schematic block diagram illustrating an example of a storage device 1000 according to an example embodiment.

The storage device 1000 according to an example embodiment may perform an operation of checking a connection state to check whether a connection state between a first chip 1100 and a second chip 1200 is poor. During the operation of checking the connection state, the storage device 1000 according to an example embodiment may utilize a training command used for a training operation. Accordingly, a check may be efficiently made to determine whether the connection state between the first chip 1100 and the second chip 1200 is poor.

This will be described in more detail with reference to FIG. 1. The storage device 1000 according to an example embodiment may include a first chip 1100 and a second chip 1200. The first chip 1100 and the second chip 1200 may transmit and receive data signals DQ0 to DQn and a data strobe signal DQS.

The first chip 1100 may include a plurality of data input/output pins P1_0 to P1_n, and may transmit and receive the data signals DQ0 to DQn to and from the second chip 1200 through the plurality of data input/output pins P1_0 to P1_n. Also, the first chip 1100 may include the data strobe pin P1_DQS, and may transmit and receive the data strobe signal DQS to and from the second chip 1200 through a data strobe pin P1_DQS.

The first chip 1100 may be, for example, a memory controller controlling the overall operation of the second chip 1200, for example, a memory device. However, this is merely an example, and the first chip 1100 may be implemented as various types of circuits transmitting and receiving the data signals DQ0 to DQn and the data strobe signal DQS to and from the second chip 1200. For example, the first chip 1100 may be a system-on-a chip (SoC), or may be a buffer chip.

The second chip 1200 may include a plurality of data input/output pins P2_0 to P2_n and a data strobe pin P2_DQS. The plurality of data input/output pins P2_0 to P2_n of the second chip 1200 may correspond to the plurality of data input/output pins P1_0 to P1_n of the first chip 1100, respectively, and the data strobe pin P2_DQS of the second chip 1200 may correspond to the data strobe pin P1_DQS of the first chip 1100. The second chip 1200 may transmit and receive the data signals DQ0 to DQn and the data strobe signal DQS to and from the first chip 1100 through a plurality of data input/output pins P2_0 to P2_n and a data strobe pin P2_DQS.

The second chip 1200 may be, for example, a memory device including a nonvolatile memory or a volatile memory. However, this is merely an example, and the second chip 1200 may be implemented to include various types of storage devices such as a memory, a register, and a buffer.

In an example embodiment, the second chip 1200 may include a nonvolatile memory, and the nonvolatile memory may include nonvolatile memory cells such as flash memory cells, resistive RAM (RRAM) cells, phase change RAM (PRAM) cells, magnetic memory (MRAM) cells, ferroelectric RAM (FRAM) cells, or spin transfer torque random access memory (STT-RAM) cells.

In an example embodiment, the second chip 1200 may include a volatile memory such as a dynamic random access memory (DRAM). In an example embodiment, the second chip 1200 may be implemented to include a storage device such as a buffer or a register. In an example embodiment, the second chip 1200 may be implemented to include a heterogeneous memory and/or storage device.

The first chip 1100 and the second chip 1200 may be implemented to be physically connected to each other. For example, the first chip 1100 and the second chip 1200 may be each implemented as a semiconductor package, and may be implemented to have a package-on-package (POP) structure in which the second chip 1200 is disposed on the first chip 1100. However, this is just an example, and the first chip 1100 and the second chip 1200 may be connected to each other through various packaging techniques. For example, the storage device 1000 may be packaged in various forms, such as package on package (POP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multichip package (MCP), wafer-level fabricated package (WFP), or wafer-level processed stack package (WSP).

In a packaging process of physically connecting the first chip 1100 and the second chip 1200 to each other, a poor connection between the first chip 1100 and the second chip 1200 may occur. The poor connection occurring in the packaging process may be referred to as poor assembly. Such poor assembly may impede smooth data transmission between the first chip 1100 and the second chip 1200. Therefore, it is desired to check whether the connection state between the first chip 1100 and the second chip 1200 is poor.

Moreover, a training operation between the first chip 1100 and the second chip 1200 may be performed in the state in which the poor assembly occurs. The training operation is performed to improve reliability of data exchange between the first chip 1100 and the second chip 1200, and may refer to an operation of detecting a center of an eye pattern or an operation of aligning transmission or an operation of transmission or arrival timings of data signals. When a training operation is performed in the state in which poor assembly occurs, the training operation may be processed as a failure. In this case, it takes a large amount of time to analyze that the failure in the training operation is caused by the poor assembly. Accordingly, before the training operation is performed, it is desired to check whether the connection state between the first chip 1100 and the second chip 1200 is poor.

To check whether the connection state between the first chip 1100 and the second chip 1200 is poor, the storage device 1100 according to an example embodiment may include a connection checking module 1110. The connection checking module 1110 may include a training pattern setting module 1120 and a frequency control module 1130.

The connection checking module 1110 may check whether the connection state between the first chip 1100 and the second chip 1200, using a training command and/or a training pattern used for a training operation. The operation of checking whether the connection state between the first chip 1100 and the second chip 1200 is poor may be referred to as a “connection state checking operation.”

In an example embodiment, during the connection state checking operation, the connection checking module 1110 may check whether the connection state between the first chip 1100 and the second chip 1200 is poor, using a read training command used for a read training operation.

For example, a desired (or alternatively, predetermined) read training pattern may be shared between the first chip 1100 and the second chip 1200. The connection checking module 1110 may transmit the read training command to the second chip 1200, and the second chip 1200 may transmit a stored read training pattern to the first chip 1100 in response thereto. The connection checking module 1110 may check whether the connection state is poor based on a read training pattern stored in the first chip 1100 and the read training pattern received from the second chip 1200. For example, the connection checking module 1110 may compare a read training pattern stored in the first chip 1100 with the read training pattern received from the second chip 1200, to check whether the connection state is poor. The read training command and/or the read training pattern used for the connection state checking operation may be substantially the same as or similar to a command and/or a pattern used for a read training operation.

In an example embodiment, during the connection state checking operation, the connection checking module 1110 may check whether the connection state between the first chip 1100 and the second chip 1200 is poor, using a write training command used for a write training operation.

For example, the connection checking module 1110 may transmit a first write training command and a write training pattern to the second chip 1200, and the second chip may store the write training pattern. Then, the connection checking module 1110 may transmit a second write training command to the second chip 1200, and the second chip 1200 may read a stored write training pattern in response thereto and transmit the write training pattern to the first chip 1100. The connection checking module 1110 may check whether the connection state is poor based on the write training pattern stored in the first chip 1100 and the write training pattern received from the second chip 1200. For example, the connection checking module 1110 may compare the write training pattern stored in the first chip 1100 with the write training pattern received from the second chip 1200, to check whether the connection state is poor. The write training command and/or the write training command used during the connection state checking operation may be substantially the same as or similar to a command and/or a pattern used for the write training operation.

The training pattern setting module 1120 may set a training pattern used for the connection state checking operation. The training pattern set by the training pattern setting module 1120 may be substantially the same as or similar to a pattern used for a training operation. Accordingly, the training pattern set by the training pattern setting module 1120 may be used for both the connection state checking operation and the training operation. However, this is just an example. In some example embodiments, the training pattern used for the connection state checking operation may be partially changed during the training operation.

The frequency control module 1130 may control a frequency in the connection state checking operation and/or the training operation. As an example, the second chip 1200 may operate based on a clock signal transmitted from the first chip 1100. In this case, the frequency control module 1130 may control a frequency of the clock signal, transmitted from the first chip 1100 to the second chip 1200, depending on an operation mode. As another example, the second chip 1200 may generate a clock signal based on a data strobe signal DQS transmitted from the first chip 1100. In this case, the frequency control module 1130 may control the frequency of the data strobe signal DQS, transmitted from the first chip 1100 to the second chip 1200, depending on an operation mode.

In an example embodiment, the frequency control module 1130 may control a frequency such that a frequency in the connection state checking operation is lower than a frequency in the training operation. Accordingly, a clear check may be made to determine whether the connection state of the first chip 1100 and the second chip 1200 is poor, regardless of an issue associated with signal integrity or power integrity.

For example, the connection state checking operation may be an operation of detecting whether the connection state between the first chip 1100 and the second chip 1200 is poor, and issues such as signal integrity or power integrity in a high-frequency training operation may be less related to whether the connection state is poor. Accordingly, to significantly reduce issues such as signal integrity, or the like, caused by a high frequency, the frequency control module 1130 may control a frequency such that a frequency in the connection state checking operation is lower than a frequency in the training operation. However, this is just an example. In some example embodiments, the frequency control module 1130 may control a frequency such that a frequency in the connection state checking operation is the same as or higher than a frequency in the training operation.

As described above, the storage device 1000 according to an example embodiment may utilize a training command used for a training operation, during a connection state checking operation. Accordingly, commands for the connection state checking operation and the training operation do not need to be set, respectively. Thus, a check may be efficiently made to determine whether the connection state between the first chip 1100 and the second chip 1200 is poor.

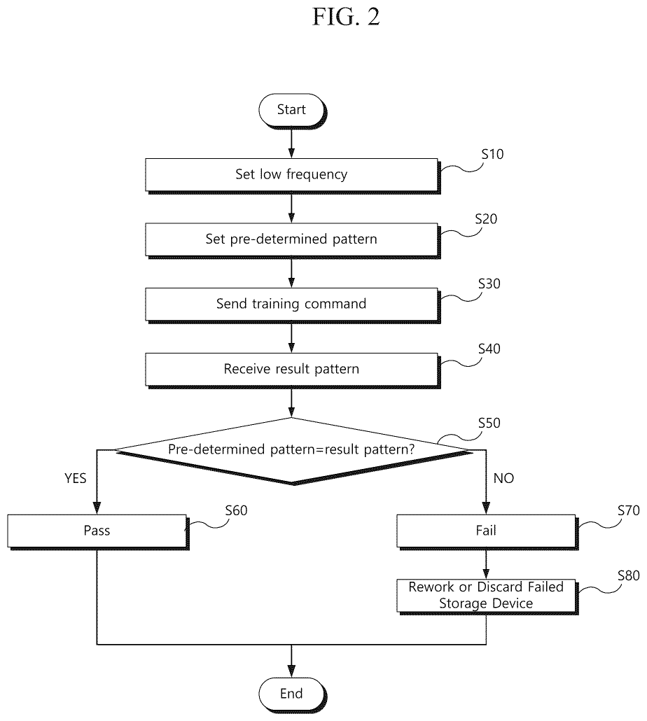

FIG. 2 is a flowchart illustrating an example of an operation of checking a connection state of the storage device 1000 of FIG. 1.

In operation S10, the frequency may be set low. For example, the first chip 1100 may control a frequency of a clock or a data strobe signal DQS such that a frequency in a connection state checking operation is lower than a frequency in a training operation.

In operation S20, a desired (or alternatively, predetermined) pattern may be set. For example, when a read training command is utilized, the first chip 1100 may set or preset a read training pattern and transmit the set pattern to the second chip 1200. In some example embodiments, a default pattern may be used as the read training pattern. In this case, operation S20 may be omitted. As another example, when a write training command is utilized, the first chip 1100 may set or preset a write training pattern and transmit the set pattern to the second chip 1200.

In operation S30, a training command may be transmitted from the first chip 1100 to the second chip 1200.

In operation S40, a result pattern may be transmitted from the second chip 1200 to the first chip 1100 in response to the training command. As an example, when a read training command is utilized, the first chip 1100 may receive a read training pattern from the second chip 1200. As another example, when a write training command is utilized, the first chip 1100 may receive a write training pattern from the second chip 1200.

In operation S50, a desired (or alternatively, predetermined) pattern and the result pattern may be compared with each other to determine whether they are the same. For example, when a read training command is utilized, the first chip 1100 may compare the desired (or alternatively, predetermined) read pattern and the result pattern received from the second chip 1200, to determine whether they are the same. As another example, when a write training command is used, the first chip 1100 may compare a desired (or alternatively, predetermined) write pattern and the pattern, received from the second chip 1200, to determine whether they are the same.

When the desired (or alternatively, predetermined) pattern and the result pattern are the same, the flow may proceed to operation S60 to determine that the connection state between the first chip 1100 and the second chip 1200 is not poor. In this case, a training operation may be performed according to some example embodiments. The training command and/or pattern utilized in the training operation, may be substantially the same as or similar to the command and/or pattern utilized in the connection state checking operation.

When the desired (or alternatively, predetermined) pattern and the result pattern are not the same, the flow may proceed to operation S70 to determine that the connection state between the first chip 1100 and the second chip 1200 is poor. In this case, information on the poor connection state may be separately managed. For example, information on a byte or a data input/output pin, which is determined to fail, may be separately managed, and may be used to improve a debugging or packaging process. When the connection state between the first chip 1100 and the second chip 1200 is determined to be poor, the storage device 1000 including the first chip 1100 and the second chip 1200 may be reworked or discarded in operation S80.

As described above, the storage device 1000 according to an example embodiment may utilize a training command, used for a training operation, during a connection state checking operation. Accordingly, a check may be efficiently made to determine whether the connection state between the first chip 1100 and the second chip 1200 is poor.

The connection state checking operation of the storage device 1000 described in FIGS. 1 and 2 may be variously applied. Hereinafter, various example embodiments will be described in more detail.

### [SoC Checking Poor State of Connection to DRAM Using Training Command]

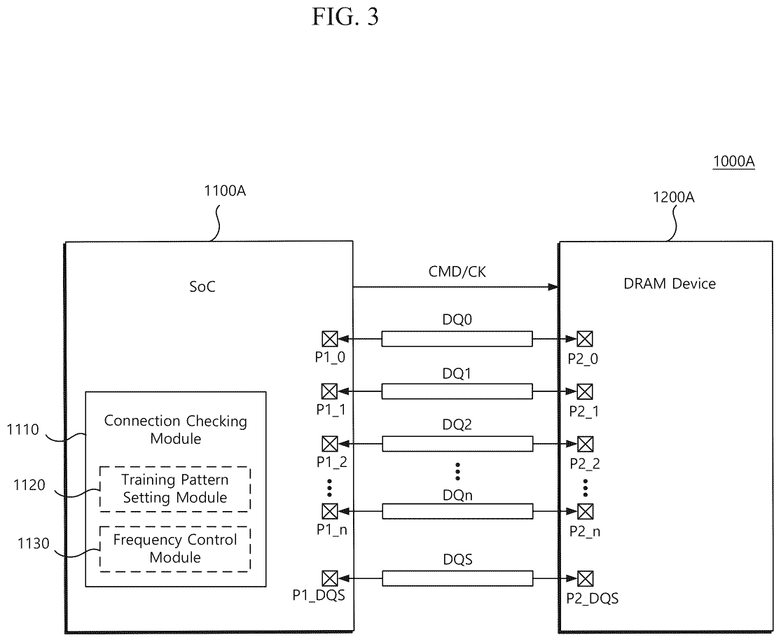

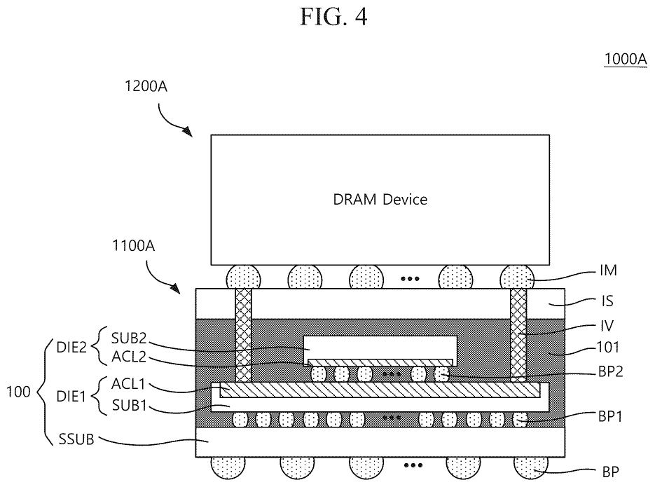

FIG. 3 is a schematic block diagram illustrating an example of the storage device of FIG. 1, and FIG. 4 is a cross-sectional view illustrating an example of a structure of the storage device of FIG. 3. As an example, FIGS. 3 and 4 illustrate an example in which the second chip of FIG. 1 is implemented as a DRAM and the first chip is implemented as a system-on-chip (SoC). The storage device 1000A of FIGS. 3 and 4 is similar to the storage device 1000 of FIG. 1. Therefore, the same or similar components are denoted by the same or similar reference numerals, and redundant descriptions thereof will be omitted below.

Referring first to FIG. 3, a storage device 1000A may include a system-on-chip 1100A and a DRAM device 1200A. The system-on-chip 1100A may include a plurality of data input/output pins P1_0 to P1_n and a data strobe pin P1_DQS, and the DRAM device 1200A may include a plurality of data input/output pins P2_0 to P2_n and a data strobe pin P2_DQS. The system-on-chip 1100A and the DRAM device 1200A may transmit and receive data signals DQ0 to DQn and a data strobe signal DQS through a plurality of pins.

The DRAM device 1200A may be provided as a main memory of the storage device 1000A. An operating system (OS) or application programs may be loaded into the DRAM device 1200A during a booting operation of the storage device 1000A. For example, when the system-on-chip 1100A is booted up, an operating system (OS) image stored in a storage device may be loaded into the DRAM device 1200A based on a booting sequence. All input/output operations of the system-on-chip 1100A may be supported by the operating system (OS).

Likewise, application programs (e.g., an application selected by a user) or an application associated with a basic service may be loaded into the DRAM 1200A. Further, the DRAM device 1200A may be used as a buffer memory storing image data provided from an image sensor such as a camera. The DRAM device 1200A may be provided in the form of a multi-chip package or module in which a plurality of chips are stacked. However, a method of manufacturing or a form of the DRAM device 1200A is not limited thereto.

The system-on-chip 1100A may execute various applications based on a user's request. The system-on-chip 1100A may load an application into the DRAM device 1200A to execute the application. The system-on-chip 1100A may drive an operating system (OS) and may execute various applications on the operating system (OS). For such an operation, the system-on-chip 1100A may write data in the DRAM device 1200A or may read data stored in the DRAM device 1200A.

Referring to FIG. 4, each of the system-on-chip 1100A and the DRAM device 1200A may be implemented as a semiconductor package. The storage device 1000A may be implemented in a POP structure in which the DRAM device 1200A is disposed on the system-on-chip 1100A.

The system-on-chip 1100A may include an SoC package substrate SSUB and at least one logic die mounted on the SoC package substrate SSUB. For example, a first die DIE1 and a second die DIE2 may be mounted on the SoC package substrate SSUB, as illustrated in FIG. 4.

The SoC package substrate SSUB may be electrically connected to a printed circuit board (PCB) (not shown) through an internal connection terminal BP.

A plurality of logic dies may be stacked on the SoC package substrate SSUB in a direction, perpendicular to the SoC package substrate SSUB. For example, the second die DIE2 may be disposed on the first die DIE1. The first die DIE1 may be electrically connected to the SoC package substrate SSUB through a first bump BP1. The second die DIE2 may be electrically connected to the first die DIE1 and the SoC package substrate SSUB through a second bump BP2.

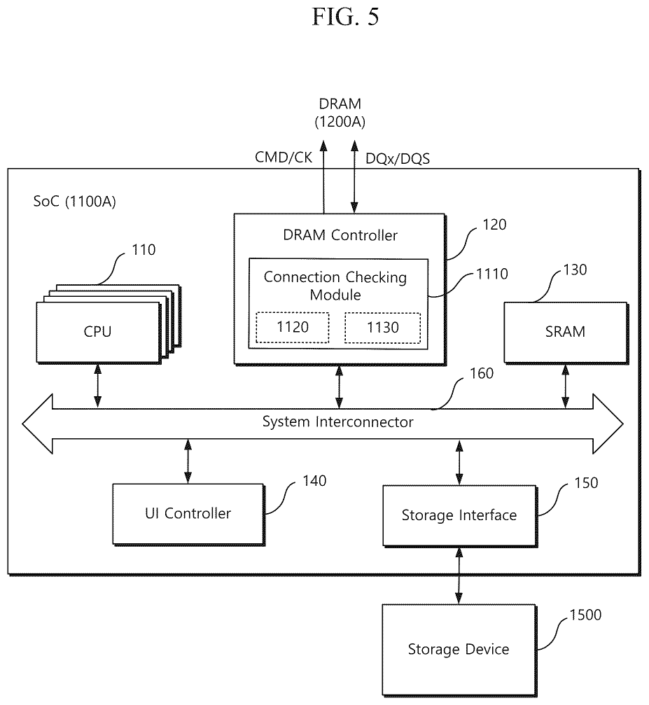

At the first die DIE1 and the second die DIE2, logic circuits included in the system-on-chip 1100A may be implemented and a plurality of intellectual properties (IPs) may be implemented. For example, components of the system-on-chip 1100A to be described in FIG. 5 may be implemented at the first die DIE1 and/or the second die DIE2.

The first die DIE1 may include a first substrate SUB1 and a first active layer ACL1. First logic circuits may be formed at the first active layer ACL1. For example, the first active layer ACL1 may include a plurality of first semiconductor devices.

The second die DIE2 may include a second substrate SUB2 and a second active layer ACL2. Second logic circuits may be formed at the second active layer ACL2. For example, the second active layer ACL2 may include a plurality of second semiconductor devices formed on the second substrate SUB2.

The first semiconductor devices formed on the first active layer ACL1 and the second semiconductor devices formed on the second active layer ACL2 may be microelectronic devices, and may include, for example, a metal-oxide-semiconductor field effect transistor (MOSFET), a system large scale integration (LSI), an image sensor such as a CMOS imaging sensor (CIS), a micro-electro-mechanical system (MEMS), an active element, a passive element, or the like.

The system-on-chip 1100A may include a molding layer 101 surrounding the first die DIE and the second die DIE2. The molding layer 101 may serve to protect the first and second dies DIE1 and DIE2 from external influences such as impact and contamination.

An interposer substrate IS may include a redistribution substrate, and may be configured to electrically connect the system-on-chip 1100A and the DRAM device 1200A to each other.

The DRAM device 1200A may be disposed on the interposer substrate IS, and may be electrically connected to the interposer substrate IS through a connection terminal IM. The DRAM device 1200A may have a structure in which a plurality of memory dies are stacked. For example, the DRAM device 1200A may have a structure in which a plurality of memory dies are stacked on a buffer die.

The system-on-chip 1100A may transmit at least one of a data input/output signal DQ, a data strobe signal DQS, commands, and a clock to the DRAM device 1200A through an interconnect via IV.

Poor assembly may occur in a packaging process in which the system-on-chip 1100A and the DRAM device 1200A are physically connected to each other. For example, poor assembly may occur during formation of the connection terminal IM or the interconnect via IV. In an example embodiment, a check may be made by utilizing a training command to determine whether a connection state between the system-on-chip 1100A and the DRAM device 1200A is poor.

For example, the system-on-chip 1100A may include a connection checking module 1110, a training pattern setting module 1120, and a frequency control module 1130, as illustrated in FIG. 3. The training pattern setting module 1120 may set or preset a training pattern to be used for a connection state checking operation. The frequency control module 1130 may set a frequency in the connection state checking operation to be lower than a frequency in a training operation. The connection checking module 1110 may check whether the connection state is poor based on a pattern stored in the system-on-chip 1100A, and a result pattern received from the DRAM device 1200A.

In this case, the command and/or the pattern used for the connection state checking operation may be substantially the same as or similar to the command and/or pattern used for the training operation. Accordingly, an additional command and/or an additional pattern does not need to be set, so that a check may be efficiently made to determine whether the connection state between the system-on-chip 1100A and the DRAM device 1200A is poor.

FIG. 5 is a block diagram illustrating an example of the system-on-chip of FIG. 3. Referring to FIG. 5, a system-on-chip 1100A may be connected to a DRAM device 1200A and a storage device 1500. Although not illustrated, the system-on-chip 1100A may be connected to a device such as a liquid crystal display or a touch panel.

The system-on-chip 1100A may include a central processing unit (CPU) 110, a DRAM controller 120, a static random access memory (SRAM) 130, a user interface (UI) controller 140, a storage interface 150, and a system interconnector 160. However, this is merely an example, and components of the system-on-chip 1100A are not limited to those illustrated in the drawing.

The CPU 110 executes software (for example, an application program, an operating system, device drivers, or the like) to be executed in the system-on-chip 1100A. The CPU 110 may execute an operating system (OS) loaded into the DRAM device 1200A. The CPU 110 may execute various application programs to be driven based on the operating system (OS). For example, the CPU 110 may fetch and execute a connection state checking code loaded into the SRAM 130 or the DRAM device 1200A. The CPU 110 may control the DRAM controller 120 to perform a connection state checking operation requested based on the execution of the connection state checking code.

The DRAM controller 120 may provide interfacing between the DRAM device 1200A and the system-on-chip 1100A. The DRAM controller 120 may access the DRAM device 1200A in response to a request of the CPU 110 or another intellectual property (IP). For example, the DRAM controller 120 may write data in the DRAM device 1200A in response to a write request from the CPU 110. Alternatively, the DRAM controller 120 may read data from the DRAM device 1200A and transmit the read data to the CPU 110 or the storage interface 150.

The SRAM 130 may be provided as a working memory of the CPU 110. For example, a boot loader for executing booting or codes may be loaded into the SRAM 130. For example, a connection state checking code may also be loaded into the SRAM 130 to perform a connection state checking operation.

The user interface controller 140 may control user input and output from user interface devices (e.g., a keyboard, a touch panel, or a display).

The storage interface 150 may control the storage device 1500 in response to a request of the CPU 110. For example, the storage interface 150 may provide an interfacing between the system-on-chip 1100A and the storage device 1500.

The system interconnector 160 may be a system bus providing an on-chip network inside the system-on-chip 1100A. The system interconnector 160 may include, for example, a data bus, an address bus, and a control bus.

The storage device 1500 may be provided as a storage medium of the system-on-chip 1100A. The storage device 1500 may store application programs, an operating system image (OS Image), and various types of data. For example, a training code for training the DRAM device 1200A may be stored in a specific area of the storage device 1500.

In an example embodiment, the DRAM controller 120 of the system-on-chip 1100A may include a connection checking module 1110, a training pattern setting module 1120, and a frequency control module 1130. Accordingly, the DRAM controller 120 may check whether a connection state between the system-on-chip 1100A and the DRAM device 1200A is poor, using a training command.

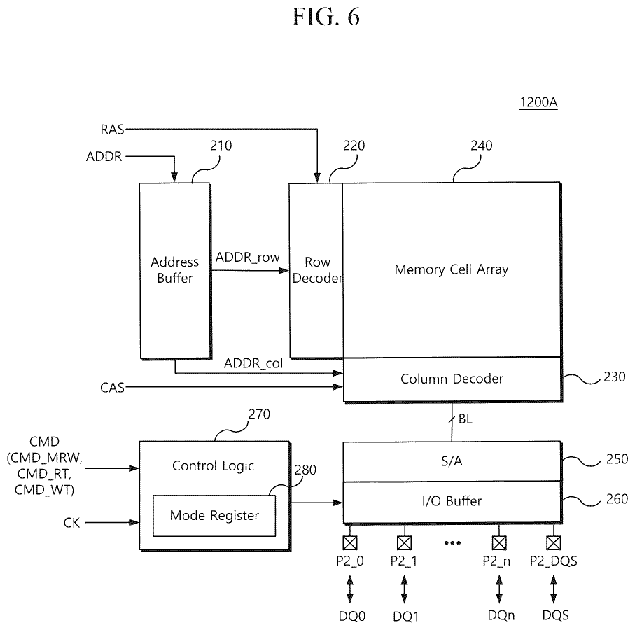

FIG. 6 is a block diagram illustrating an example of the DRAM device 1200A of FIG. 3. Referring to FIG. 6, a DRAM device 1200A may include an address buffer 210, a row decoder 220, a column decoder 230, a memory cell array 240, a sense amplifier 250, an input/output buffer 260, and a control logic 270.

The address buffer 210 may receive an address ADDR from a DRAM controller 120. The address buffer 210 may transmit a row address ADDR_row to the row decoder 220, and may transmit a column address ADDR_col to the column decoder 230.

The row decoder 220 may select a single wordline, among a plurality of wordlines connected to the memory cell array 240, in response to the row address ADDR_row.

The column decoder 230 may select a single bitline, among a plurality of bitlines BL connected to the memory cell array 240, in response to the column address ADDR_col. The column decoder 230 may activate the selected bitline in response to a control signal CAS.

The memory cell array 240 may include a plurality of memory cells. The plurality of memory cells may be disposed at intersections of the plurality of wordlines and the plurality of bitlines, respectively. The plurality of memory cells may be connected to the plurality of wordlines and the plurality of bitlines. Each of the plurality of memory cells may be provided in a matrix form. The plurality of wordlines may be connected to rows of memory cells of the memory cell array 240. The plurality of bitlines may be connected to columns of memory cells of the memory cell array 240.

The memory cell array 240 may include, for example, dynamic random access memory (DRAM) cells, synchronous DRAM (SDRAM) cells, double date rate SDRAM (DDR SDRAM) cells, low power DDR (LPDDR) SDRAM cells, or the like. However, this is merely exemplary, and memory cells of the memory cell array 240 may be provided as random access memory (RAM) cells such as phase-change RAM (PRAM) cells, magnetic RAM (MRAM) cells, or static RAM (SRAM) cells.

The sense amplifier 250 may be connected to a plurality of bitlines connected to the memory cell array 240. The sense amplifier 250 may sense a change in voltage at an activated bitline, among the plurality of bitlines, and may amplify and output the changed voltage.

The input/output buffer 260 may output data signals DQ0 to DQn and a data strobe signal DQS to an external device through data input/output pins P2_0 to PE_n and a date strobe pin P2_DQS based on the voltage amplified by the sense amplifier 250.

The control logic 270 may include a mode register 280. Data on configuration and status depending on an operation mode supported by the DRAM device 1200A may be stored in the mode register 280. In addition, a training pattern for performing a connection state checking operation according to an example embodiment may be stored in the mode register 280.

The control logic 270 may receive various commands and clocks from the DRAM controller 120, and may control the overall operation of the DRAM device 1200A.

In an example embodiment, a check may be made by utilizing a read training command to determine whether a connection state between the system-on-chip 1100A and the DRAM device 1200A is poor. In this case, the read training pattern may be stored in the mode register 280. For example, the control logic 270 may receive a mode register write command CMD_MRW, and the control logic 270 may store the read training pattern in the mode register 280 in response thereto. Then, when the read training command CMD_RT is received, the read training pattern stored in the mode register 280 may be transmitted to the system-on-chip 1100A through the data input/output pins P2_0 to P2_n.

In an example embodiment, a check may be made by utilizing a write training command to determine whether the connection state between the system-on-chip 1100A and the DRAM device 1200A is poor. In this case, the write training pattern may be stored in the memory cell array 240. For example, the control logic 270 may receive a first write training command CMD_WT1, and the control logic 270 may store the write training pattern in the memory cell array 240 in response thereto. Then, when a second write training command CMD_WT2 is received, the write training pattern stored in the memory cell array 240 may be transmitted to the system-on-chip 1100A through the data input/output pins P2_0 to P2_n.

As described above, a check may be made by utilizing a command used for a training operation to determine whether the connection state between the system-on-chip 1100A and the DRAM device 1200A is poor.

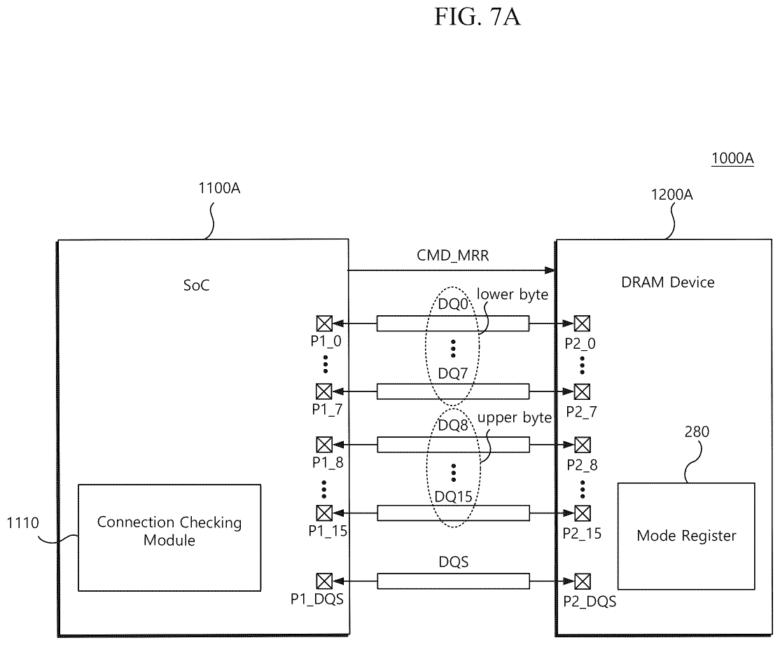

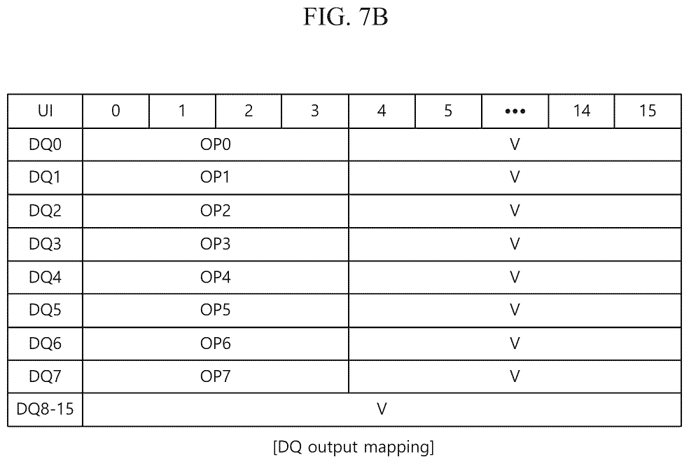

FIGS. 7A and 7B are diagrams illustrating an operation of checking a connection state according to an example embodiment. For example, FIG. 7A illustrates an example of an operation of a storage device checking poor assembly by utilizing a mode register read command CMD_MRR, and FIG. 7B illustrates an example of a data pattern output in response to the mode register read command CMD_MRR. For ease of description, in FIG. 7A, an example is provided where the storage device 1000A is an LPDDR4 SDRAM and the DRAM device 1200A has a single channel die having a 16-bit width.

Referring to FIG. 7A, the system-on-chip 1100A and the DRAM device 1200A may transmit and receive data signals in units of 8 bits. First 8 bits of data DQ0 to DQ7 may be referred to as a lower byte or byte 0, and the next 8 bits of data DQ8 to DQ15 may be referred to as an upper byte or byte 1.

A data pattern for configuration and status corresponding to a mode register read operation may be stored in the mode register 280 of the DRAM device 1200A. In this case, according to the specification of the LPDDR4 SDRAM, the data pattern stored in the mode register 280 may correspond only to the lower byte.

This will be described in more detail with reference to FIG. 7B. The data pattern stored in the mode register 280 may be divided into data signals DQ0 to DQ7, corresponding to the lower byte, and data signals DQ8 to DQ15 corresponding to the upper byte. Each of the data signals DQ0 to DQ7 corresponding to the lower byte may have a desired (or alternatively, predetermined) operand for first four UIs. For example, the data signals DQ0 to DQ7 corresponding to the lower byte may constitute a data pattern. On the other hand, each of the data signals DQ8 to DQ15 corresponding to the upper byte may have valid but undefined contents, or may have no contents.

Accordingly, when the mode register read command CMD_MRR is received, the DRAM device 1200A may provide the data pattern corresponding to the lower byte to the system-on-chip 1100A through the data input/output pins P2_0 to P2_7. The system-on-chip 1100A may receive the data pattern corresponding to the lower byte through the data input/output pins P1_0 to P1_7, and may compare the received data pattern with a data pattern stored in the system-on-chip 1100A. Thus, a check may be made to determine whether a connection state between the data input/output pins P1_0 to P1_7 and P2_0 to P2_7 corresponding to the lower byte is poor. In some example embodiments, a connection state between the data input/output pins P1_0 to P1_7 and P2_0 to P2_7 corresponding to the lower byte is poor may be checked based on the received data pattern with a data pattern stored in the system-on-chip 1100A.

However, the data pattern corresponding to the upper byte is not defined, so that the method utilizing the mode register read command CMD_MRR has a limitation of being unable to check whether the connection state between the data input/output pins P1_8 to P1_15 and P2_8 to P2_15 corresponding to the upper byte is poor.

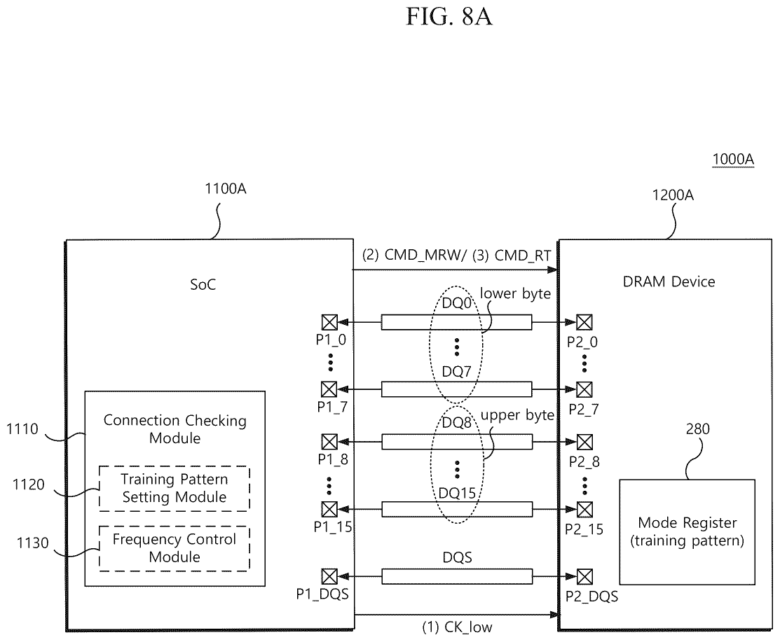

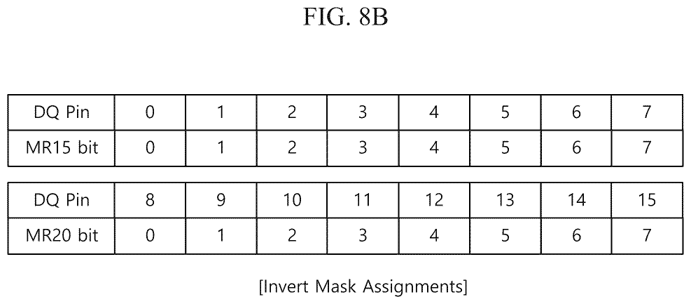

FIGS. 8A and 8B are diagrams illustrating an operation of checking a connection state according to an example embodiment. For example, FIG. 8A illustrates an example of an operation of a storage device of checking poor assembly by utilizing a read training command CMD_RT, and FIG. 8B illustrates an example of a read training pattern corresponding to the read training command CMD_RT. For ease of description, similarly to FIGS. 7A and 7B, an example is provided where the storage device 1000A of FIG. 8 is an LPDDR4 SDRAM and the DRAM device 1200A has a single channel die having a 16-bit width.

Referring to FIG. 8A, the system-on-chip 1100A and the DRAM device 1200A may transmit and receive data signals in units of 8 bits. A read training pattern corresponding to a read training command CMD_RT may be stored in the mode register 280 of the DRAM device 1200A. In this case, according to the specification of the LPDDR4 SDRAM, the read training pattern stored in the mode register 280 may correspond to both a lower byte and an upper byte. Accordingly, through a connection state checking operation utilizing the read training command CMD_RT, a check may be made to determine whether a connection state between data input/output pins corresponding to the upper byte is poor, as well as whether a connection state between data input/output pins corresponding to the lower byte is poor.

A more detailed description is provided. During the connection state checking operation, the frequency control module 1130 of the system-on-chip 1100A may set a frequency of a clock, which is to be transmitted to the DRAM device 1200A, to be low. Accordingly, an accurate check may be made to determine whether the connection state between the data input/output pins is poor, without an issue associated with signal integrity or power integrity.

Then, the training pattern setting module 1120 of the system-on-chip 1100A may set a read training pattern. In this case, the read training pattern may correspond to both a lower byte and an upper byte.

Then, the connection checking module 1130 of the system-on-chip 1100A may transmit a mode register write command CMD_MRW to the DRAM device 1200A.

Accordingly, the read training pattern may be stored in the mode register 280 of the DRAM device 1200A.

According to some example embodiments, the mode register 280 may include a plurality of registers MRs, and a read training pattern corresponding to first 8 bits may be stored in a register MR32 and a read training pattern corresponding to next 8 bits may be stored in a register MR15.

According to some example embodiments, an eight-bit invert mask corresponding to a lower byte may be stored in the register MR15 and an eight-bit invert mask corresponding to an upper byte may be stored in a register MR20, as illustrated in FIG. 8B.

According to some example embodiments, a plurality of default patterns may be stored in the registers MRs of the mode register 280. For example, a value of ‘5Ah’ may be stored in a register MR32, a value of ‘3Ch’ may be stored in a register MR40, a value of ‘55h’ may be stored in a register MR15, and a value of ‘55h’ may be stored in a register MR20. When the default patterns are stored as described above, an operation of issuing the mode register write command CMD_MRW may be omitted.

Then, the connection checking module 1110 of the system-on-chip 1100A may transmit a read training command CMD_R to the DRAM Device 1200A. The read training command CMD_RT may be referred to as, for example, a read DQ calibration command. In this case, the DRAM device 1200A may provide a read training pattern corresponding to a lower byte to the system-on-chip 1100A through the data input/output pins P2_0 to P2_7, and may provide a read training pattern corresponding to an upper byte to the system-on-chip 1100A through the data input/output pins P2_8 to P2_15.

Then, the system-on-chip 1100A may compare a stored read training pattern and the read training pattern received from the DRAM device 1200A. Accordingly, a check may be made to determine whether a connection state between the data input/output pins P1_8 to P1_15 and the data input/output pins P2_8 to P2_15 corresponding to the upper byte is poor, as well as whether a connection state between the data input/output pins P1_0 to P1_7 and the data input/output pins P2_0 to P2_7 corresponding to the lower byte is poor. In some example embodiments, a determination as to whether a connection state between the data input/output pins P1_8 to P1_15 and the data input/output pins P2_8 to P2_15 corresponding to the upper byte is poor, as well as whether a connection state between the data input/output pins P1_0 to P1_7 and the data input/output pins P2_0 to P2_7 corresponding to the lower byte is poor may be made based on a stored read training pattern and the read training pattern received from the DRAM device 1200A.

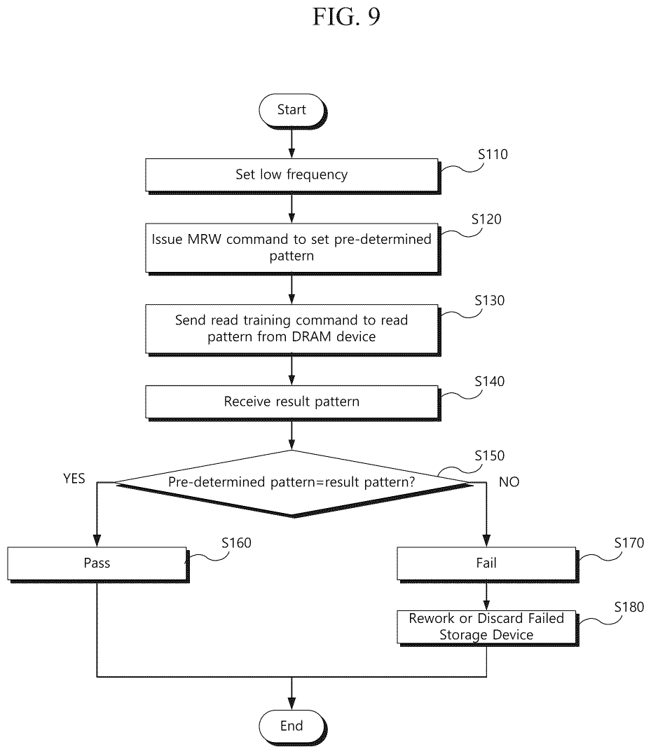

FIG. 9 is a flowchart illustrating an example of a connection state checking operation utilizing a read training command CMD_RT.

In operation S110, the frequency may be set low. For example, the system-on-chip 1100A (see FIG. 8A) may control a frequency of a clock or a data strobe signal DQS such that a frequency in a connection state checking operation is lower than a frequency in a training operation.

In operation S120, a mode register write command CMD_MRW may be issued to set a desired (or alternatively, predetermined) pattern. For example, the system-on-chip 1100A may issue the mode register write command CMD_MRW to the DRAM device 1200A (see FIG. 8A), and thus the read training pattern corresponding to the lower byte and the read training pattern corresponding to the upper byte may be stored in the mode register 280 (see FIG. 8A).

According to some example embodiments, a default pattern may be stored in the mode register 280. In this case, operation S120 in which the mode register write command CMD_MRW is issued may be omitted.

In operation S130, the system-on-chip 1100A may send a read training command CMD_RT (see FIG. 8A) to the DRAM device 1200A to read the read training pattern stored in the DRAM device 1200A.

In operation S140, a result pattern may be transmitted from the DRAM device 1200A to the system-on-chip 1100A. The result pattern refers to a read training pattern stored in the DRAM device 1200A, and may include both a read training pattern corresponding to a lower byte and a read training pattern corresponding to an upper byte.

In operation S150, the desired (or alternatively, predetermined) pattern stored in the system-on-chip 1100A and a result pattern may be compared with each other to determine whether they are the same. The desired (or alternatively, predetermined) pattern may refer to a read training pattern before being sent to the DRAM device 1200A.

When the desired (or alternatively, predetermined) pattern and the result pattern are the same, the flow may proceed to S160 to determine that the connection state between the system-on-chip 1100A and the DRAM device 1200A is not poor, which may be treated as PASS. Then, according to some example embodiments, a reading training operation may be performed. In this case, a read training command and a read training pattern used in the training operation may be substantially the same as the command and the pattern used in the connection state checking operation.

When the desired (or alternatively, predetermined) pattern and the result pattern are not the same, the flow may proceed to operation S170 to determine that the connection state between the system-on-chip 1100A and the DRAM device 1200A is poor, which may be treated as FAIL. In this case, according to some example embodiments, information on the poor connection state may be separately managed. For example, information on a byte or a data input/output pin that is determined as FAIL may be separately managed, and may be utilized to improve a debugging or packaging process. When the connection state the system-on-chip 1100A and the DRAM device 1200A is determined to be poor, the storage device 1000A including the system-on-chip 1100A and the DRAM device 1200A may be reworked or discarded in operation S180.

As described above, the storage device 1000A according to an example embodiment may utilize a read training command during a connection state checking operation. Accordingly, a check may be efficiently made to determine whether the connection state between the system-on-chip 1100A and the DRAM device 1200A is poor.

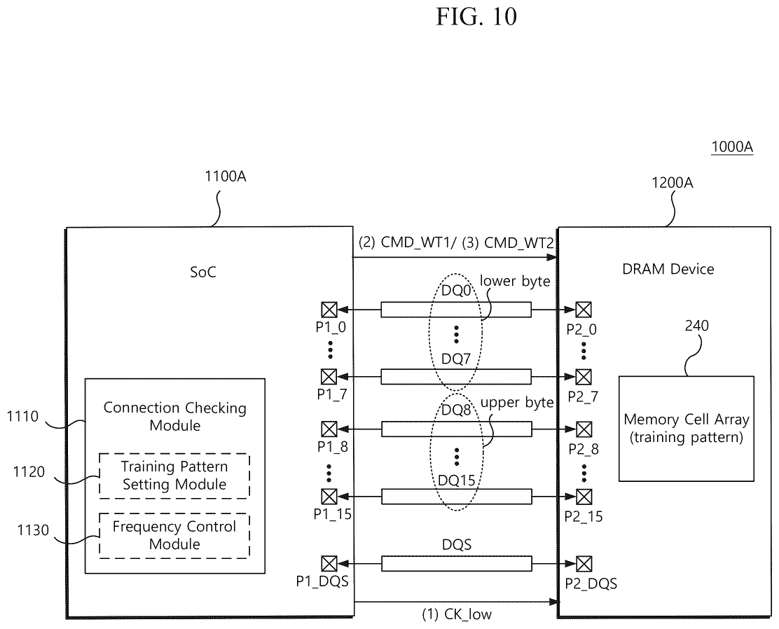

FIG. 10 is a diagram illustrating a connection state checking operation according to an example embodiment. For example, FIG. 10 illustrates an example of an operation of a storage device of checking poor assembly by utilizing a write training command CMD_WT. For ease of description, similarly to in FIGS. 7A, 7B, 8A and 8B, an example is provided where the storage device 1000A of FIG. 10 is an LPDDR4 SDRAM and the DRAM device 1200A has a single channel die having a 16-bit width. The operation of the storage device 1000A of FIG. 10 is similar to that of FIGS. 8A and 8B. Therefore, the same or similar components and operations are denoted by the same or similar reference numerals, and redundant descriptions will be omitted below.

Referring to FIG. 10, during a connection state checking operation, the frequency control module 1130 of the system-on-chip 1100A may set a frequency of a clock, transmitted to the DRAM device 1200A, to be low.

Then, the training pattern setting module 1120 of the system-on-chip 1100A may set a write training pattern. In this case, the write training pattern may correspond to both a lower byte and an upper byte.

Then, the connection checking module 1130 of the system-on-chip 1100A may transmit a first write training command CMD_WT1 to the DRAM device 1200A. The first write training command CMD_WT1 may be referred to as, for example, a write DQ command or a write DQ FIFO command. Accordingly, the write training pattern may be stored in the memory cell array 240 of the DRAM device 1200A. According to an example embodiment, a plurality of first write training commands CMD_WT1 may be continuously transmitted to the DRAM device 1200A.

Then, the connection checking module 1110 of the system-on-chip 1100A may transmit a second write training command CMD_WT2 to the DRAM device 1200A. The second write training command CMD_WT2 may also be referred to as, for example, a read DQ command or a read DQ FIFO command. In this case, the DRAM device 1200A may provide a write training pattern corresponding to a lower byte, among a plurality of pieces of data stored in the memory cell array 240, to the system-on-chip 1100A through data input/output pins P2_0 to P2_7, and may provide a write training pattern corresponding to an upper byte, among the plurality of pieces of data stored in the memory cell array 240, to the system-on-chip 1100A through data input/output pins P2_8 to P2_15.

Then, a check may be made to determine whether a connection state between data input/output pins corresponding to a lower byte is poor, as well as whether a connection state between data input/output pins corresponding to an upper byte is poor based on a stored write training pattern and a write training pattern received from the DRAM device 1200A. For example, the system-on-chip 1100A may compare a stored write training pattern with a write training pattern received from the DRAM device 1200A to determine a connection state between data input/output pins corresponding to an upper byte.

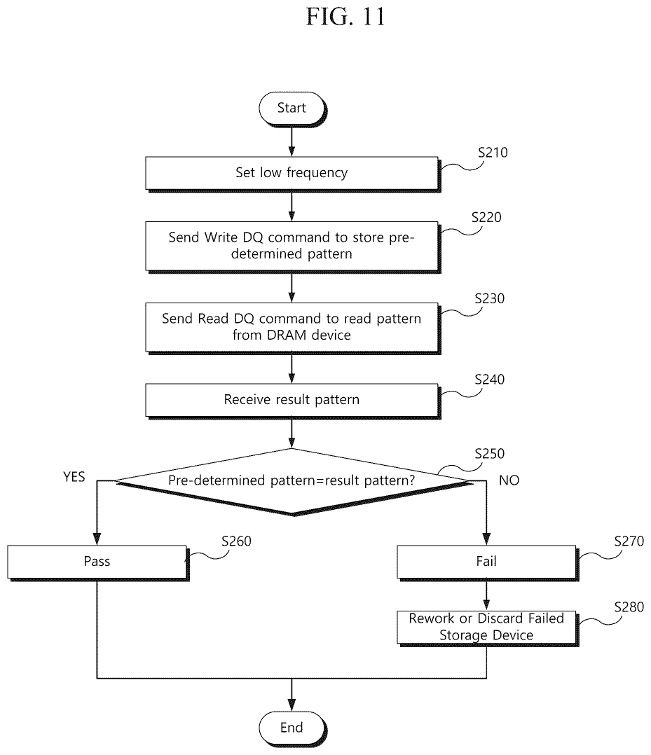

FIG. 11 is a flowchart illustrating an example of an operation of checking a connection state utilizing a write training command CMD_WT. The operation of checking the connection state utilizing the write training command CMD_WT of FIG. 11 is similar to the operation utilizing the read training command CMD_RT of FIG. 9. Therefore, for brevity of description, redundant descriptions will be omitted below.

In operation S210, a frequency may be set low.

In operation S220, a write DQ command may be sent to the DRAM device 1200A to store a write training pattern in the memory cell array 240 (see FIG. 10). The write training pattern may include both a write training pattern corresponding to a lower byte and a write training pattern corresponding to an upper byte. The write DQ command may be referred to as, for example, a first write training command CMD_WT1.

In operation S230, the system-on-chip 1100A may send a read DQ command to the DRAM devoice 1200A to read a write training pattern stored in the memory cell array 240 of the DRAM device 1200A. The read DQ command may be referred to as, for example, a second write training command CMD_WT2.

In operation S240, a result pattern may be transmitted from the DRAM device 1200A to the system-on-chip 1100A. The result pattern refers to a write training pattern stored in the DRAM device 1200A, and may include both a read training pattern corresponding to a lower byte and a read training pattern corresponding to an upper byte.

In operation S250, a pattern (for example, a write training pattern) desired (or alternatively, predetermined) in the system-on-chip 1100A and the result pattern may be compared with each other to determine whether they are the same.

When the desired (or alternatively, predetermined) pattern and the result pattern are the same, the flow may proceed to operation S160 to determine that the connection state between the system-on-chip 1100A and the DRAM device 1200A is not poor, which may be treated as PASS. Then, according to an example embodiment, a write training operation may be performed. In this case, the command and pattern used for the write training operation may be substantially the same as the command and pattern used for the connection state checking operation.

When the desired (or alternatively, predetermined) pattern and the result pattern are not the same, the flow may proceed to operation S170 to determine that the connection state between the system-on-chip 1100A and the DRAM device 1200A is poor, which may be treated as FAIL. In this case, information on a byte or a data input/output pin, which is determined to fail, may be separately managed, and may be used to improve a debugging or packaging process. When the connection state between the system-on-chip 1100A and the DRAM device 1200A is determined to be poor, the storage device 1000A including the system-on-chip 1100A and the DRAM device 1200A may be reworked or discarded in operation S280.

As described above, the storage device 1000A according to an example embodiment may utilize a write training command during a connection state checking operation. Accordingly, a check may be efficiently made to determine whether a connection state between the system-on-chip 1100A and the DRAM device 1200A is poor.

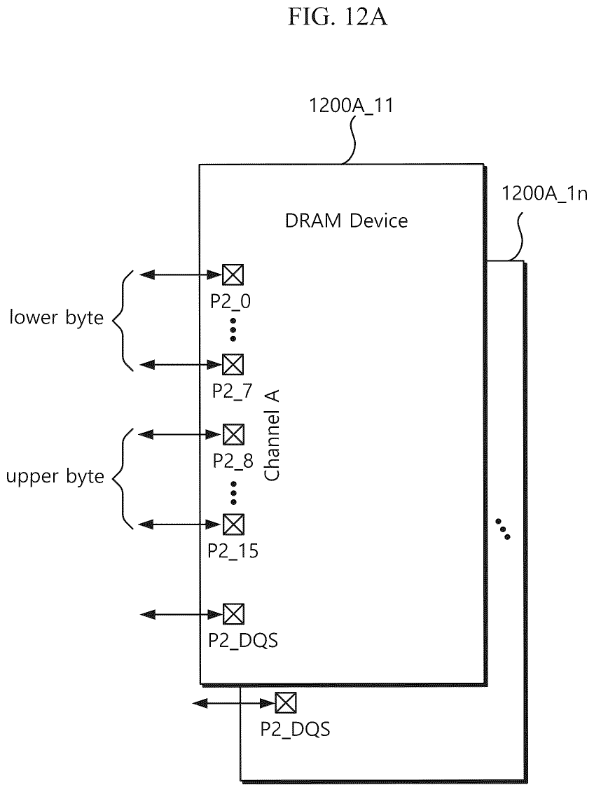

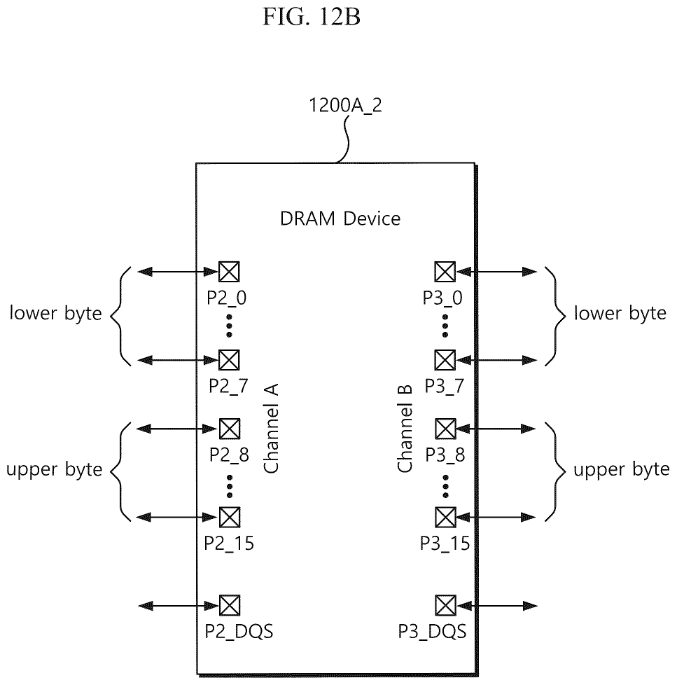

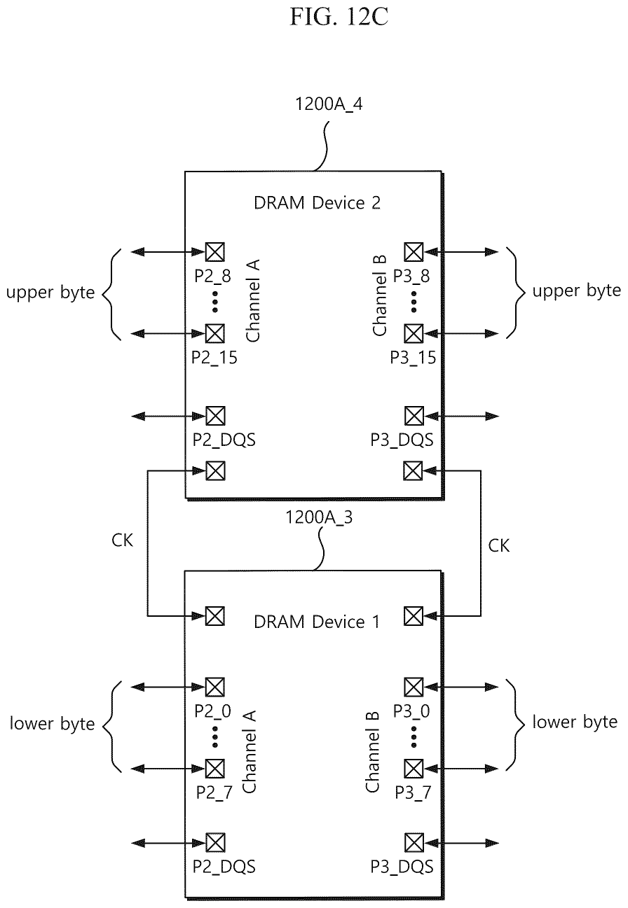

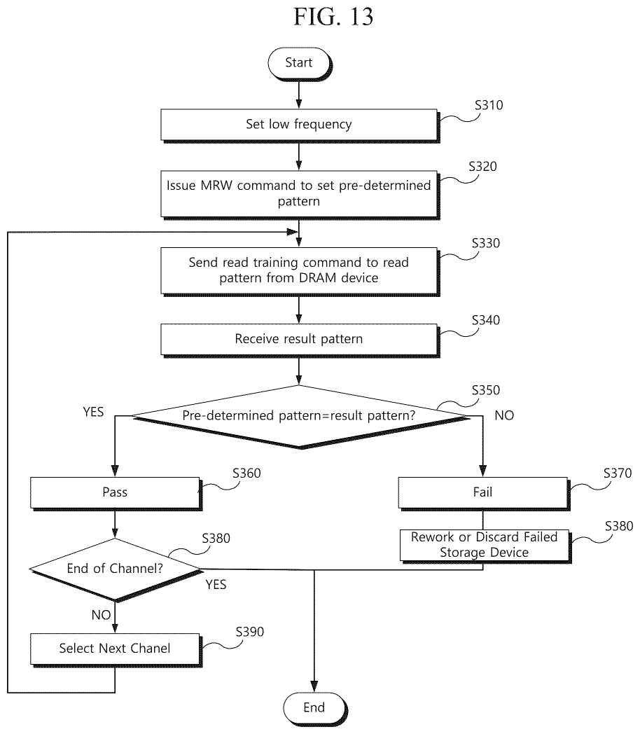

In FIGS. 7A to 11, the DRAM device has been described as having a single channel die. However, this is merely an example, and example embodiments are not limited thereto. For example, a DRAM device may be implemented to have a multi-channel structure or a dual-die structure. Even in this case, a storage device according to an example embodiment may perform a connection state checking operation by utilizing a training command. This will be described below in more detail with reference to FIGS. 12A to 12C and FIG. 13.

FIGS. 12A, 12B, and 12C are diagrams illustrating DRAM devices having a plurality of channels according to some example embodiments.

Referring to FIG. 12A, a plurality of DRAM devices 1200A_11 to 1200A_In may be provided. The plurality of DRAM devices 1200A_11 to 1200A_In may be connected to the system-on-chip 1100A (see FIG. 3). Each of the plurality of DRAM devices 1200A_11 to 1200A_In may be connected to the system-on-chip 1100A through a channel.

Each channel may be implemented to correspond to both a lower byte and an upper byte, as illustrated in FIG. 12A. For example, each channel may be implemented as a standard type having a 16-bit width. However, this is merely an example, and a portion of a plurality of channels may be implemented to correspond to lower bytes and another portion of the plurality of channels may be implemented to correspond to upper bytes.

Referring to FIG. 12B, a DRAM device 1200A_2 may be implemented to have a dual channel die. For example, one side of the die of the DRAM device 1200A_2 may constitute a first channel Channel A and the other side may constitute a second channel Channel B, as illustrated in FIG. 12B. However, this is merely an example, and a die of a DRAM device may be implemented to have three or more channels.

Referring to FIG. 12C, a DRAM device may be implemented to have a two-byte mode dual channel die. For example, a first DRAM device 1200A_3 and a second DRAM device 1200A_4 may be provided and each of the first and second DRAM devices 1200A_3 and 1200A_4 may have a dual channel die, as illustrated in FIG. 12C. Each of the first and second channels Channel A and Channel B formed on opposite sides of the first DRAM device 1200A_3 may correspond to a lower byte, and each of the first and second channels Channel A and Channel B formed on opposite sides of the second DRAM device 1200A_4 may correspond to an upper byte. However, this is merely an example, and three or more DRAM devices may be provided, and each die of the DRAM device may be implemented to have three or more channels.

As described above, a storage device according to an example embodiment may be connected to a DRAM device through multiple channels. Even in this case, the storage device according to an example embodiment may efficiently check a connection state between data input/output pins corresponding to an upper byte as well as a connection state between data input/output pins corresponding to a lower byte by utilizing a read training command or a write training command.

FIG. 13 is a flowchart illustrating an example of an operation of checking a connection state for a DRAM device having multiple channels. For ease of description, in FIG. 13, an example is provided where an operation of checking a connection state is performed by utilizing a read training command CMD_RT. The operation of checking a connection state of FIG. 13 is similar to that of FIG. 9. Therefore, redundant descriptions will be omitted below.

In operation S310, a frequency may be set low.

In operation S320, a mode register write command CMD_MRW may be issued to store a desired (or alternatively, predetermined) pattern in the mode register. Accordingly, a read training pattern corresponding to a lower byte and a read training pattern corresponding to an upper byte may be stored in the mode register.

In operation S330, the system-on-chip may transmit a read training command CMD_RT to the DRAM device to read a read training pattern stored in the DRAM device. In operation S340, a result pattern may be transmitted from the DRAM device 1200A to the system-on-chip 1100A.

In operation S350, the result pattern and a desired (or alternatively, predetermined) pattern, stored in the system-on-chip, may be compared with each other to determine whether they are the same.

When the desired (or alternatively, predetermined) pattern and the result pattern are the same, the flow may proceed to operation S360 to determined that a connection state between the system-on-chip and the DRAM device is not poor, which may be treated as PASS. In operation S380, a check may be made to determine whether a channel, on which the connection state checking operation has been performed, is a last channel. When there is a channel on which the connection state checking operation has not been performed, a next channel may be selected in operation S390, and the connection state checking operation may continue to be performed on the selected next channel.

Meanwhile, when the desired (or alternatively, predetermined) pattern and the resultant pattern are not the same, the flow may proceed to operation S370 to determine that the connection state between the system-on-chip 1100A and the DRAM device 1200A is poor, which may be treated as FAIL. When the connection state between the system-on-chip 1100A and the DRAM device 1200A is determined to be poor, the storage device 1000A including the system-on-chip 1100A and the DRAM device 1200A may be reworked or discarded in operation S380.

As described above, the storage device according to an example embodiment may include a DRAM device having multiple channels, and may efficiently check a connection state between the DRAM device and the system-on-chip by utilizing a training command.

It will be appreciated that the above description is merely an example, and example embodiments are not limited thereto. For example, in FIGS. 3 to 13, a frequency has been described as being set low first for an operation of checking a connection state. However, this is merely an example, and the frequency may be set low after the training pattern is stored in a mode register or a memory cell array. In addition, according to some example embodiments, the frequency may be set to be the same as a frequency used for the training operation.

In addition, in FIGS. 3 to 13, the second chip of FIG. 1 has been described as being a volatile memory such as a DRAM. However, this is merely an example and the second chip of FIG. 1 may be implemented as a nonvolatile memory or as a buffer chip. This will be described in more detail below.

### [Controller Checking Whether State of Connection to Nonvolatile Memory is Poor, by Utilizing Training Command]

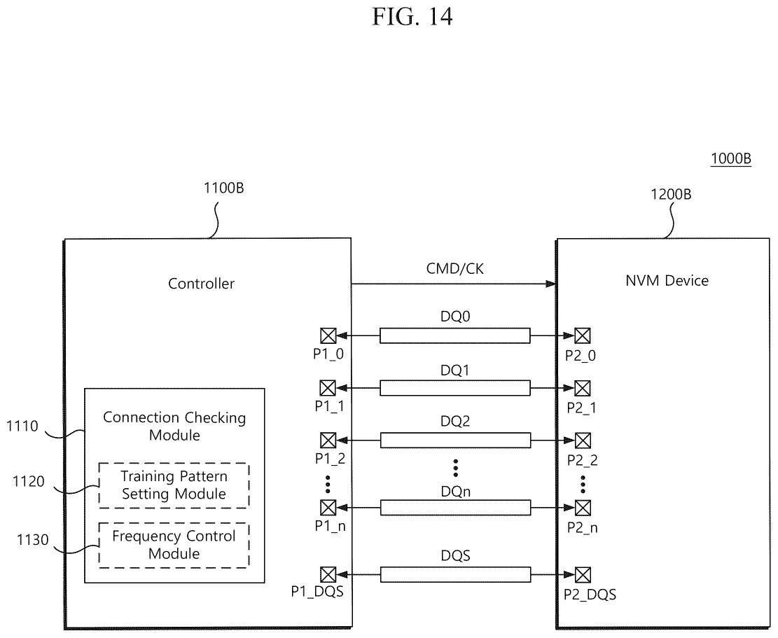

FIG. 14 is a diagram illustrating another example of the storage device of FIG. 1. For example, FIG. 14 illustrates an example in which the second chip of FIG. 1 is implemented as a nonvolatile memory device and the first chip of FIG. 1 is implemented as a controller. The storage device 1000B of FIG. 14 is similar to the storage devices 1000 and 1000A of FIGS. 1 and 3. Therefore, the same or similar components are denoted by the same or similar reference numerals, and redundant descriptions will be omitted below.

Referring to FIG. 14, the storage device 1000B may include a controller 1100B and a nonvolatile memory device 1200B.

The nonvolatile memory device 1200B may include various memories such as a flash memory, a phase change memory (PRAM), a magnetoresistive memory (MRAM), a resistive memory (RRAM), or a ferroelectric memory (FRAM). The nonvolatile memory device 1200B may include homogeneous memories or heterogeneous memories.

The controller 1100B may be configured to control the nonvolatile memory device 1200B. For example, the controller 1100B may control the nonvolatile memory device 1200B to perform a write, read, or erase operation. Also, the controller 1100B may perform an operation of checking a state of connection to the nonvolatile memory device 1200B and a data training operation.

In an example embodiment, the controller 1100B may check whether a connection state between the controller 1100B and the nonvolatile memory device 1200B by utilizing a training command. For example, the controller 1100B may include a connection checking module 1110, a training pattern setting module 1120, and a frequency control module 1130, as illustrated in FIG. 14. The training pattern setting module 1120 may set or preset a training pattern to be used for a connection state checking operation. The frequency control module 1130 may set a frequency in the connection state checking operation to be lower than a frequency in the training operation. The connection checking module 1110 may compare a pattern stored in the system-on-chip 1100A with a result pattern received from the DRAM device 1200A to check whether a connection state is poor. In some example embodiments, the connection checking module 1110 may check whether a connection state is poor based on a pattern stored in the system-on-chip 1100A and a result pattern received from the DRAM device 1200A. In this case, a command and/or a pattern used in the connection state checking operation may be substantially the same as or similar to a command and/or a pattern used in the training operation. Accordingly, an additional command and/or an additional pattern does not need to be set, and thus a check may be efficiently made to determine whether the connection state between the controller 1100B and the nonvolatile memory device 1200B is poor.

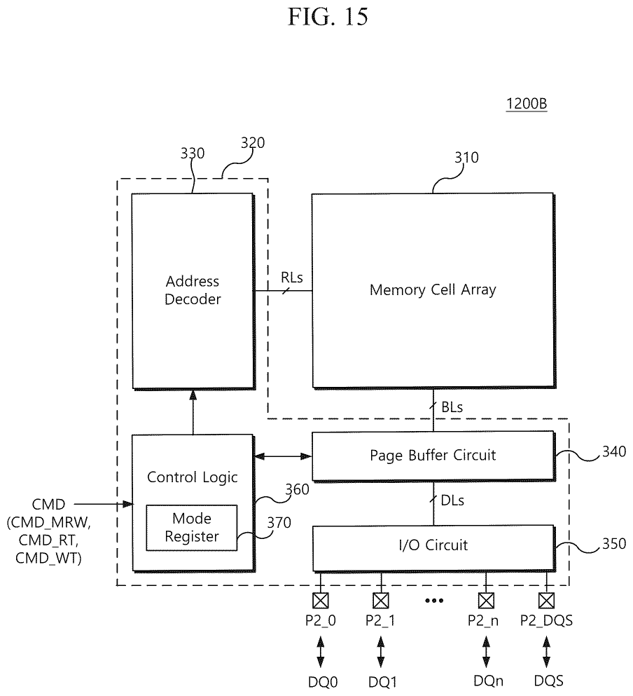

FIG. 15 is a block diagram illustrating the nonvolatile memory device 1200B of FIG. 14 in more detail.

Referring to FIG. 15, the nonvolatile memory device 1200B may include a memory cell array 310 and a peripheral circuit 320, and the peripheral circuit 320 may include an address decoder 330, a page buffer circuit 340, an input/output circuit 350, and a control logic 360.

The memory cell array 310 may include a plurality of memory blocks. Each of the memory blocks may have a two-dimensional structure or a three-dimensional structure. In a memory block having a two-dimensional structure (or a horizontal structure), memory cells may be formed in a direction, parallel to a substrate. In a memory block having a three-dimensional structure (or a vertical structure), memory cells may be formed in a direction, perpendicular to a substrate.

The address decoder 330 may be connected to the memory cell array 310 through row lines RLs. The row lines RLs may include string select lines SSLs, ground select lines GSLs, wordlines WLs, and dummy wordlines DWLs.

The page buffer circuit 340 may be connected to the memory cell array 310 through bitlines BLs. The page buffer circuit 340 may temporarily store data to be programmed in a selected page or data read from the selected page.

The input/output circuit 350 may be internally connected to the page buffer circuit 340 through data lines DLs, and may externally be connected to a controller 1100B through data input/output pins P2_0 to P2_n and a data strobe pin P2_DQS.

The control logic 360 may control the overall operation of the nonvolatile memory device 1200B. The control logic 360 may include a mode register 370.

In an example embodiment, a check may be made by utilizing a read training command to determine whether a connection state between the controller 1100B and the nonvolatile memory device 1200B is poor. In this case, the read training pattern may be stored in the mode register 370. For example, the control logic 360 may receive a mode register write command CMD_MRW, and the control logic 360 may store a read training pattern in the mode register 370 in response thereto. Then, when the read training command CMD_RT is received, the read training pattern stored in the mode register 370 may be transmitted to a controller 1100B through data input/output pins P2_0 to P2_n.

In an example embodiment, a check may be made by utilizing a write training command to determine whether a connection state between the controller 1100B and the nonvolatile memory device 1200B is poor. In this case, the write training pattern may be stored in the memory cell array 310. For example, a first write training command CMD_WT1 may be received by the control logic 360, and the control logic 360 may store a write training pattern in the memory cell array 310 in response to the first write training command CMD_WT1. Then, when the second write training command CMD_WT2 is received, the write training pattern stored in the memory cell array 310 may be transmitted to the controller 1100B through the data input/output pins P2_0 to P2_n.

As described above, a check may be made by utilizing a command to determine whether a connection state between the controller 1100B and the nonvolatile memory device 1200B is poor.

### [Storage Device Including Buffer Chip]

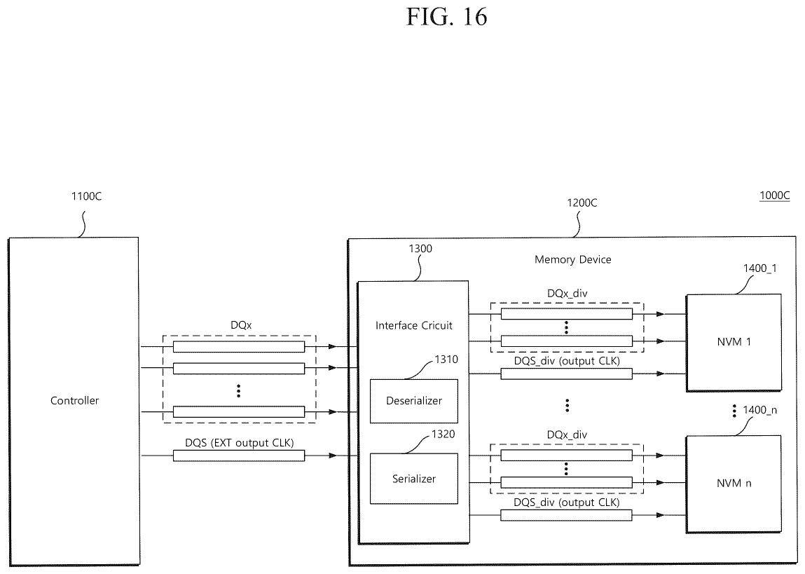

FIG. 16 is a diagram illustrating another example of the storage device of FIG. 1. For example, in FIG. 16, an interface circuit 1300 may operate as the first chip of FIG. 1 or the second chip of FIG. 1. A storage device 1000C of FIG. 16 is similar to the storage devices 1000, 1000A, and 1000B of FIGS. 1, 3, and 14. Therefore, the same or similar components are denoted by the same or similar reference numerals, and redundant descriptions will be omitted below.

Referring to FIG. 16, a storage device 1000C may include a controller 1100C and a memory device 1200C. The memory device 1200C may include an interface circuit 1300 and a plurality of nonvolatile memories 1400_1 to 1400_n.

The controller 1100C and the interface circuit 1300 may respectively a plurality of data input/output pins and a data strobe pin, and a data signal DQx and a data strobe signal DQS may be transmitted through the plurality of data input/output pins and the data strobe pin.

In addition, the interface circuit 1300 and the nonvolatile memories 1400_1 to 1400_n may respectively include a plurality of data input/output pins and a data strobe pin, and a data signal DQx and a data strobe signal DQS may be transmitted through the data input/output pins and the data strobe pin.

The controller 1100C may write data in the plurality of nonvolatile memories 1400_1 to 1400_n in response to a write request, or may receive data from the plurality of nonvolatile memories 1400_1 to 1400_n in response to a read request.

Each of the plurality of nonvolatile memories 1400_1 to 1400_n may store write-requested data or read stored data. One of the plurality of nonvolatile memories 1400_1 to 1400_n may include nonvolatile memory cells such as flash memory cells, RRAM cells, PRAM cells, MRAM cells, FRAM cells, or STT-RAM cells.

The interface circuit 1300 may provide interfacing between the plurality of nonvolatile memories 1400_1 to 1400_n and the controller 1100C.

In an example embodiment, the interface circuit 1300 may perform a buffering operation to compensate for a difference in operating speeds between the controller 1100C and the nonvolatile memories 1400_1 to 1400_n. Because the interface circuit 1300 performs a buffering operation, the interface circuit 1300 may be referred to as a buffer chip or a buffer circuit.

During an operation of the buffer chip, a frequency when data is exchanged between the controller 1100C and the interface circuit 1300 may be different from a frequency when data is exchanged between the interface circuit 1300 and the nonvolatile memories 1400_1 to 1400_n. For example, a frequency when data is exchanged between the controller 1100C and the interface circuit 1300 may be higher than a frequency when data is exchanged between the interface circuit 1300 and the nonvolatile memories 1400_1 to 1400_n. For example, a frequency of a first DQS signal corresponding to an external clock signal EXT CLK may be higher than a frequency of a second DQS signal corresponding to an internal clock signal INT CLK.

In an example embodiment, the interface circuit 1300 may receive the data signals DQx from the controller 1100C and may divide and store a plurality of pieces of write data, included in the data signals DQx, to the nonvolatile memories 1400_1 to 1400_n, respectively. To this end, the interface circuit 1300 may include a deserializer 1310 dividing write data received from the controller 1100C. In this case, a frequency of a divided data strobe signal DQS_div corresponding to the internal clock signal INT CLK may be decreased as compared with a frequency of the data strobe signal DQS corresponding to the external clock signal EXT CLK. For example, when writing data is divided and written to n nonvolatile memories, the frequency of the divided data strobe signal DQS_div may be equal to 1/n times the frequency of the data strobe signal DQS.

In addition, in an example embodiment, the interface circuit 1300 may receive divided data signals DQx_div from the plurality of nonvolatile memories 1400_1 to 1400_n, and may combine and transmit a plurality of pieces of read data included in the data signals DQx_div to the controller 1100C. To this end, the interface circuit 1300 may include a serializer 1320 combining read data received from the plurality of nonvolatile memories 1400_1 to 1400_n. In this case, the frequency of the divided data strobe signal DQS_div may be lower than the frequency of the data strobe signal DQS.

An operation of checking a connection state according to an example embodiments may be performed to check whether a connection state between the controller 1100C and the interface circuit 1300 is poor. In addition, the operation of checking a connection state according to an example embodiments may be performed to check whether a connection state between the interface circuit 1300 and the plurality of nonvolatile memories 1400_1 to 1400_n is poor.

In this case, according to an example embodiment, a first frequency for checking whether the connection state between the controller 1100C and the interface circuit 1300 is poor may be different from a second frequency for checking whether the connection state between the interface circuit 1300 and the plurality of nonvolatile memories 1400_1˜1400_n is poor. For example, the second frequency may be set to be lower than the first frequency.

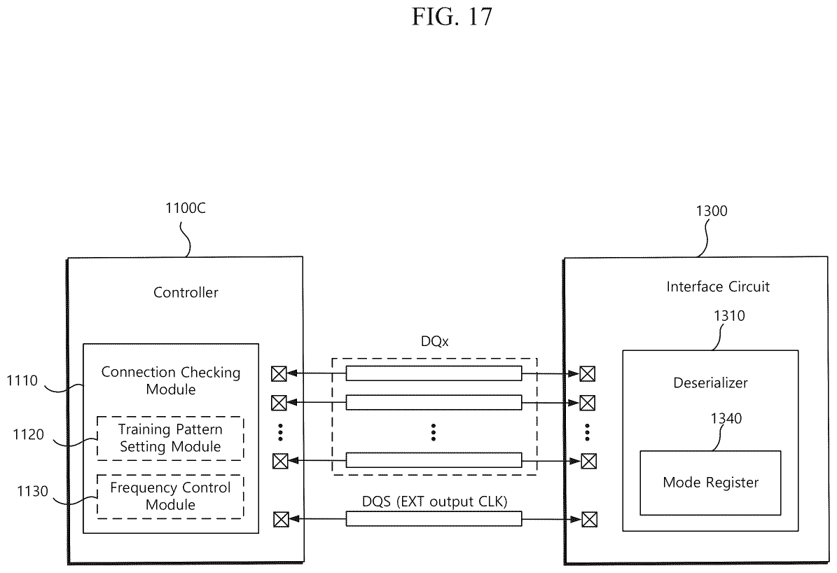

FIG. 17 is a diagram illustrating an operation of checking a connection state between the controller 1100C and the interface circuit 1300 in the storage device 1000C of FIG. 16.

Referring to FIG. 17, the controller 1100C may include a connection checking module 1110, a training pattern setting module 1120, and a frequency control module 1130. The deserializer 1310 of the interface circuit 1300 may include a mode register 1340.

The training pattern setting module 1120 may set or preset a training pattern to be used for an operation of checking a connection state.

The frequency control module 1130 may set a frequency in the operation of checking a connection state to be lower than a frequency in a training operation. For example, the frequency control module 1130 may set the frequency in the operation of checking a connection state check to be lower than the frequency of the data strobe signal DQS corresponding to the external clock signal EXT CLK.

The mode register 1340 may store a training pattern. The connection checking module 1110 may compare the training pattern, stored in the controller 1100C, with a result pattern, received from the interface circuit 1300, to check whether a connection state is poor. Accordingly, a check may be efficiently made to determine whether the connection state between the controller 1100C and the interface circuit 1300 is poor.

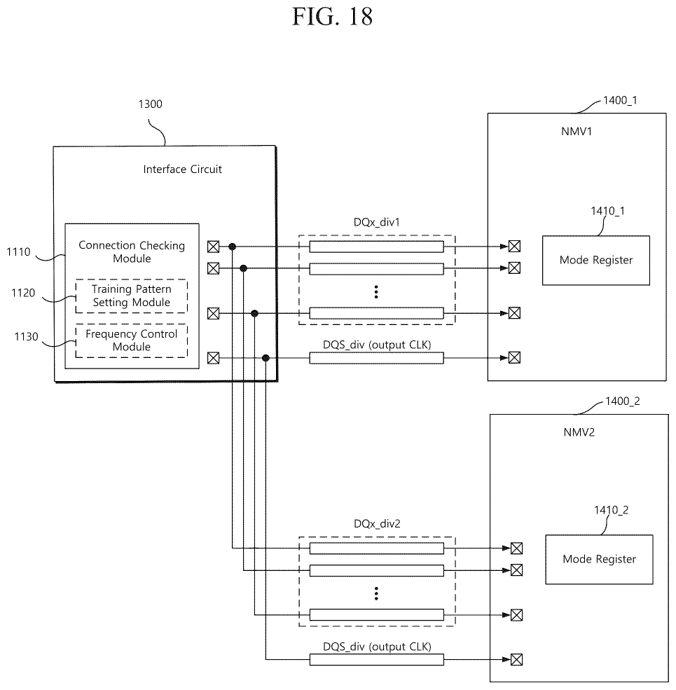

FIG. 18 is a diagram illustrating an operation of checking a connection state between the interface circuit 1300 and the nonvolatile memories 1400_1 and 1400_2 in the storage device 1000C of FIG. 16. For ease of description, in FIG. 18, an example is provided where data is divided and written in two nonvolatile memories 1400_1 and 1400_2.

Referring to FIG. 18, an interface circuit 1300 may segment and transmit a plurality of data signals DQx to a first nonvolatile memory 1400_1 and a second nonvolatile memory 1400_2. In this case, a divided data strobe signal DQS_div corresponding to an internal clock INT CLK may be transmitted to the first nonvolatile memory 1400_1 together with segmented first data signals DQx_div1.

Similarly, the divided data strobe signal DQS_div may be transmitted to the second nonvolatile memory 1400_2 together with segmented second data signals DQx_div2. Because data is divided and written in the two nonvolatile memories 1400_1 and 1400_2, a frequency of the divided data strobe signal DQS_div corresponding to an internal clock INT CLK may be equal to half times a frequency of the data strobe signal DQS corresponding to an external clock EXT CLK.

In an example embodiment, the interface circuit 1300 may include a connection checking module 1110, a training pattern setting module 1120, and a frequency control module 1130. The nonvolatile memories 1400_1 and 1400_2 may include mode registers 1410_1 and 1410_2, respectively.

During an operation of checking a connection state, the training pattern setting module 1120 may set or preset a training pattern to be used for the operation of checking a connection state.

The frequency control module 1130 may set a frequency in the operation of checking a connection state to be lower than a frequency in a training operation. For example, the frequency control module 1130 may set the frequency in the operation of checking a connection state to be lower than a frequency of the divided data strobe signal DQS_div. In this case, a frequency in the operation of checking the connection state between the interface circuit 1300 and the nonvolatile memories 1400_1 and 1400_2 may be lower than a frequency in the operation of checking the connection state between the controller 1100C and the interface circuit 1300 described in FIG. 17.

The mode register 1340 may store a training pattern. The connection checking module 1110 may compare a pattern, stored in the interface circuit 1300, with a result pattern received from the nonvolatile memories 1400_1 and 1400_2. Accordingly, a check may be efficiently made to determine whether a connection state between the interface circuit 1300 and the nonvolatile memories 1400_1 and 1400_2 is poor.

Any functional blocks, units, or modules shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

As set forth above, according to some example embodiments, a storage device may effectively check whether a connection state is poor.

While some example embodiments have been shown and described above, it will be apparent to those skilled in the art that modifications and variations could be made without departing from the scope of the present inventive concepts as defined by the appended claims.

What is claimed is:

1. A storage device comprising:
a first chip; and
a second chip connected to the first chip and configured to exchange a plurality of data signals with the first chip,
wherein
the first chip and the second chip are configured to align the plurality of data signals using a training command during a training operation, and
the first chip and the second chip are configured to check whether a connection state between first data input/output pins of the first chip and second data input/output pins of the second chip is poor, by utilizing the training command, during a connection state checking operation.

2. The storage device of claim 1, wherein
a frequency of a clock in the connection state checking operation is lower than a frequency of a clock in the training operation.

3. The storage device of claim 1, wherein
the first chip and the second chip is configured to share a pattern, and
the second chip is configured to transmit the pattern to the first chip in response to the training command and
the first chip is configured to check whether a connection state between the first data input/output pins of the first chip and the second data input/output pins of the second chip is poor based on the pattern received from the second chip and the pattern stored in the first chip, during the connection state checking operation.

4. The storage device of claim 3, wherein
the second chip comprises a mode register,
the first chip is configured to transmit the pattern to the second chip together with a mode register write command, and
the second chip is configured to store the pattern received from the first chip in the mode register in response to the mode register write command.

5. The storage device of claim 4, wherein
the training command is a read data compensation command,
the pattern stored in the mode register comprises first data signals corresponding to a lower byte and second data signals corresponding to an upper byte, and
the second chip is configured to transmit the first data signals corresponding to the lower byte and the second data signals corresponding to the upper byte to the first chip in response to the read data compensation command.

6. The storage device of claim 3, wherein
the second chip comprises a memory cell array,
the first chip is configured to transmit the pattern to the second chip together with a write data command, and
the second chip is configured to store the pattern received from the first chip, in the memory cell array in response to the write data command.

7. The storage device of claim 6, wherein
the training command is a read data command,
the pattern stored in the memory cell array comprises first data signals corresponding to a lower byte and second data signals corresponding to an upper byte, and
the second chip is configured to transmit the first data signals corresponding to the lower byte and the second data signals corresponding to the upper byte to the first chip in response to the read data command.

8. The storage device of claim 3, wherein
the pattern is a default pattern.

9. The storage device of claim 3, wherein
the first chip is configured to transmit the pattern to the second chip together with the training command during the training operation.

10. The storage device of claim 1, wherein
the second chip comprises a plurality of DRAM devices each having a plurality of channels, and
the first chip is configured to perform the connection state checking operation on each of the plurality of DRAM devices, by utilizing the training command.

11. The storage device of claim 1, wherein
the second chip comprises a nonvolatile memory configured to store the plurality of data signals transmitted from the first chip.

12. The storage device of claim 1, further comprising:
a plurality of third chips configured to exchange data with the second chip,
wherein
the second chip and the plurality of third chips are configured to check whether a connection state between the second chip and the plurality of third chips is poor, by utilizing the training command, during the connection state checking operation.

13. The storage device of claim 1, wherein
the first chip and the second chip are packaged in a package-on-package type.

14. A method of checking a connection state between a first chip and a second chip, the method comprising:
setting a frequency of a clock signal transmitted from the first chip to the second chip, to be lower than a frequency in a training operation;
transmitting a training command from the first chip to the second chip;
transmitting a training pattern stored in the second chip to the first chip in response to the training command; and
determining a connection relationship between the first chip and the second chip based on a training pattern stored in the first chip and the training pattern transmitted from the second chip,
wherein
the training command and the training pattern stored in the first chip are a command and a pattern used for the training operation, respectively.

15. The method of claim 14, further comprising:
transmitting the training pattern stored in the first chip to the second chip together with a mode register write command; and
storing the training pattern transmitted from the first chip in a mode register of the second chip in response to the mode register write command.

16. The method of claim 14, further comprising:
transmitting the training pattern stored in the first chip to the second chip together with a write data command; and
storing the training pattern transmitted from the first chip in a memory cell array of the second chip in response to the write data command.

17. The method of claim 14, further comprising:
treating the connection state between the first chip and the second chip as pass when the training pattern stored in the first chip and the training pattern received from the second chip are same.

18. The method of claim 14, further comprising:
treating the connection state between the first chip and the second chip as fail when the training pattern stored in the first chip and the training pattern received from the second chip are different from each other.

19. A system-on-chip connected to a DRAM device, the system-on-chip comprising:
processing circuitry configured to set a training pattern;
a plurality of data pins connected to the DRAM device and configured to transmit the training pattern to the DRAM device; and
the processing circuitry further configured to determine whether a state of connection to the DRAM device is poor, based on a training pattern received from the DRAM device and the training pattern stored in the system-on-chip, during a connection state checking operation,
wherein
the training pattern stored in the system-on-chip is transmitted to the DRAM device during a training operation.

20. The system-on-chip of claim 19, wherein
the processing circuitry is further configured to set a frequency in the connection state checking operation to be lower than a frequency in the training operation.
